(19) United States
(12) Patent Application Publication
(10) Pub. No.: US 2026/0155584 A1
(43) Pub. Date: Jun. 4, 2026

(54) RING LOADED ALFORD-LOOP BASED PHASE GRADIENT METASURFACE LENS FOR X-BAND APPLICATIONS

(71) Applicant: TATA CONSULTANCY SERVICES LIMITED, Mumbai (IN)

(72) Inventors: VEDULA KIRAN BHARADWAJ, Kolkata (IN); SOUMYA CHAKRAVARTY, Kolkata (IN); TAPAS CHAKRAVARTY, Kolkata (IN); ROWDRA GHATAK, Durgapur (IN)

(73) Assignee: TATA CONSULTANCY SERVICES LIMITED, Mumbai (IN)

(21) Appl. No.: 19/332,211

(22) Filed: Sep. 18, 2025

(30) Foreign Application Priority Data
Dec. 4, 2024 (IN) 202421095638

(51) Int. Cl. H01Q 19/06; H01Q 15/00; H01Q 15/02

(52) U.S. Cl. CPC H01Q 19/065; H01Q 15/0086; H01Q 15/02

(57) ABSTRACT

Phase gradient metasurface surface plays a crucial role in wireless and satellite communication, radars and remote sensing applications. However, conventional approaches for obtaining high gain of an incident wave suffer a low phase variation. The present disclosure provides a ring loaded alford-loop based phase gradient metasurface lens for x-band applications to achieve 0-360° transmission phase variation. The phase gradient metasurface lens of present disclosure includes a two-dimensional periodic array of a plurality of unit cells arranged as a M*N matrix along x-axis and y-axis. Each of the plurality of unit cells is a four layered slot typed structure with a periodicity. Each of a plurality of unit cell layers in the four layered slot typed structure comprises a modified alford-loop structure with four L-shaped arcs and it is enclosed by an outer square ring. The four layered slot typed structures are identical and separated by an air gap.

### PRIORITY CLAIM

This U.S. patent application claims priority under 35 U.S.C. § 119 to: India application No. 202421095638, filed on Dec. 4, 2024. The entire contents of the aforementioned application are incorporated herein by reference.

### TECHNICAL FIELD

The disclosure herein generally relates to the field of metasurface antenna system and, more particularly, to ring loaded alford-loop based phase gradient metasurface lens for x-band applications.

### BACKGROUND

Wireless and satellite communication, radars and remote sensing applications require high-gain antennas for point-to-point wireless communication or radar sensing from a distance. The high-gain antennas not only improve signal to noise ratio but also are necessary for greater angular resolution for radar applications. However, to obtain such narrow beamwidth antennas, the antenna aperture must be significantly large, which increases size as well as cost. For high-gain antennas, a 360° phase variation is needed to achieve low side lobe levels. There are several research being carried out for designing the high-gain antennas such as phased array antennas, reflector antennas, and lenses that are designed for the long-distance communication applications. These techniques have their own limitations. For example, the phased array antennas enable precise electronic beamforming and steering but has high system complexity and cost. The reflector antennas typically use large passive structures to redirect the beam coming from a separate source located at an appropriate location. Active source element generally falls in line-of-sight of the output of the reflector antennas and may interfere with it. Moreover, the reflector antennas can become bulky for high gain applications and are impractical for space constrained environments. The traditional 3-D dielectric lenses, such as the Luneburg lens operate on the principle of focusing the electromagnetic wave through a graded refractive index material. However, including robustness, reduced system complexity and a wide field of view, the curved surface of homogenously varying refractive index is difficult to fabricate.

### SUMMARY

Embodiments of the present disclosure present technological improvements as solutions to one or more of the above-mentioned technical problems recognized by the inventors in conventional systems. For example, in one embodiment, a ring loaded alford-loop based phase gradient metasurface lens for x-band applications is provided. The ring loaded alford-loop based phase gradient metasurface lens for x-band applications includes a two dimensional periodic array of a plurality of unit cells arranged as a M*N matrix along x-axis and y-axis of the phase gradient metasurface lens, wherein each of the plurality of unit cells is a four layered slot typed structures with a predefined periodicity, wherein each of a plurality of unit cell layers in the four layered slot typed structure of each of the plurality of unit cells comprises a modified alford-loop structure and is enclosed by an outer square ring, wherein the modified alford-loop structure comprises of a central slot ring with four L-shaped arcs, wherein the four layered slot typed structures in the plurality of unit cells are separated by an air gap, and wherein the four layered slot typed structures in each of the plurality of unit cells are identical. The outer square ring is placed at the edge of each of the four layered slot typed structures in the plurality of unit cells to achieve a wider transmission phase variation. The four L-shaped arc lengths are determined by varying an arm length of each L-shaped arc of modified alford-loop structure until a 0-360° transmission phase variation is achieved. A transmission magnitude and the 0-360° transmission phase variation are achieved by determining total number of the four layered slot typed structures in the plurality of unit cells and the air gap between the four layered slot typed structures. The outer square ring increases a capacitance around the each of the four layered slot typed structures, the modified alford-loop structure, the air gap between the four layered slot typed structures in the plurality of unit cells, the arm lengths of four L-shaped arcs, and the four layered slot typed structures in the plurality of unit cells together achieve the 360° transmission phase variation. The phase gradient metasurface lens is connected to a transmitting antenna acting as a feeding source, wherein the transmitting antenna illuminates the phase gradient metasurface lens by an incident wave, and wherein the incident wave is converted to a directive beam by the phase gradient metasurface lens. The transmitting antenna is placed at a distance from center of the phase gradient metasurface lens, wherein the position of the transmitting antenna from the phase gradient metasurface lens determines a phase difference profile of the phase gradient metasurface lens, and wherein the phase difference observed at the center of the phase gradient metasurface lens is zero and increases at edges of the phase gradient metasurface lens.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates a 3-dimensional view of a multilayer unit cell of a ring loaded alford-loop based phase gradient metasurface lens, in accordance with some embodiments of the present disclosure.

FIG. 2 illustrates a top view of a unit cell layer of the ring loaded alford-loop based phase gradient metasurface lens, in accordance with some embodiments of the present disclosure.

FIG. 3 illustrates an exemplary implementation of the ring loaded alford-loop based phase gradient metasurface lens of FIG. 1, according to some embodiments of the present disclosure.

FIG. 4 illustrates a plot associated with the variation in transmission phase and magnitude with respect to an arm length of the multilayer unit cell of the ring loaded alford-loop based phase gradient metasurface lens, according to some embodiments of the present disclosure.

FIG. 5 illustrates a plot associated with response of a S11 bandwidth for a transmitting antenna, according to some embodiments of the present disclosure.

FIG. 6 illustrates a plot associated with a response of S21 for the arm lengths of the multilayer unit cell of the ring loaded alford-loop based phase gradient metasurface lens, according to some embodiments of the present disclosure.

FIG. 7A, 7B, 7C, 7D illustrate plots associated with the gain of the ring loaded alford-loop based phase gradient metasurface lens and the transmitting antenna system, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

For a high-gain antennas, a 360° phase variation is needed to achieve low side lobe levels. Several research being carried out for designing the high-gain antennas such as phased array antennas, reflector antennas, and lenses that are designed for the long-distance communication applications. These techniques have their own limitations. For example, the phased array antennas enable precise electronic beamforming and steering but has high system complexity and cost. The reflector antennas typically use large passive structures to redirect the beam coming from a separate source located at an appropriate location. Active source element generally falls in line-of-sight of the output of the reflector antennas and may interfere with it. Moreover, the reflector antennas can become bulky for high gain applications and are impractical for space constrained environments. The traditional 3-D dielectric lenses, such as the Luneburg lens operate on the principle of focusing the electromagnetic wave through a graded refractive index material. However, including robustness, reduced system complexity and a wide field of view, the curved surface of homogenously varying refractive index is difficult to fabricate. Phase-gradient metasurfaces (PGMS) provides high gain for the incident plane wave from a transmitarray system. A PGMS is an artificially engineered surface of sub-wavelength structures with spatial phase gradient along its surface which can alter the phase and magnitude of an incoming wave. The PGMS utilized for focusing the incident plane wave from the transmitarray system, this is achieved by tuning the dimensions of the individual elements present in the PGMS. However, to achieve 360° phase variation, a specific design and a number of layers of PGMS required to get complete transmission phase range.

To overcome the challenges of the conventional approaches, embodiments herein provide a ring loaded alford-loop based phase gradient metasurface lens for x-band applications operating at 11 GHz for X-band application to enhance the gain of transmitting antenna and achieve 360° phase variation of an incident wave.

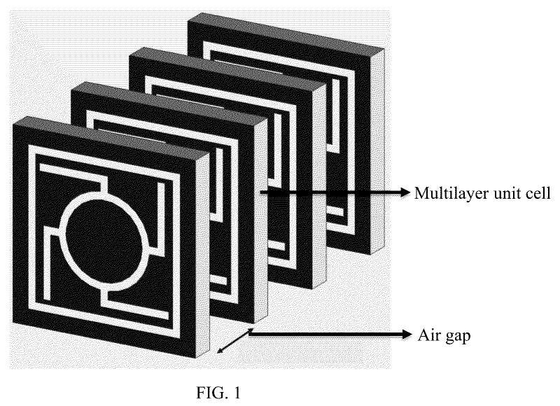

Referring now to the drawings, and more particularly to FIGS. 1 through 7D, where similar reference characters denote corresponding features consistently throughout the figures, there are shown preferred embodiments and these embodiments are described in the context of the following exemplary system and/or method.

FIG. 1 illustrates a 3-dimensional view of the multilayer unit cell of the ring loaded alford-loop based phase gradient metasurface lens, in accordance with some embodiments of the present disclosure. Now referring to FIG. 1, the multilayer unit cell layer of the phase gradient metasurface lens includes a two-dimensional periodic array of a plurality of unit cells arranged as a M*N matrix along an x-axis and a y-axis. For example, dimension of phase gradient metasurface lens is 5.7λₒ×5.7λₒ×0.62λₒ. Each of the plurality of unit cells comprises a four layered slot typed structure layers comprises a modified alford-loop structure and is enclosed by an outer square ring of a predefined length l (for example, l=10 mm) etched on a metal layer and the metal layer is mounted on a metasurface substrate with a height h (for example, h=1.6 mm). The modified alford-loop structure comprises of a central slot ring with a predefined inner radius r (for example, r=2.5 mm) with four L-shaped arcs with a predefined arm length a and a predefined thickness t (for example, t=0.5 mm). The four layered slot typed structures in the plurality of unit cells are separated by a predefined air gap (for example, value of the predefined air gap is 3.5 mm). Each of the plurality of unit cells are identical. The outer square ring is placed at the edge of the four layered slot typed structures in the plurality of unit cells, which introduces capacitance around the modified alford-loop structure to achieve a wider transmission phase variation. The predefined arm length of the four L-shaped arcs is determined by simulating the arm length between a range. For example, for simulation the arm length varying between 0.1 to 4 mm range and selecting the best arm length which contributes to achieve 0-360° transmission phase variation and a transmission magnitude.

The 0-360° transmission phase variation is achieved by determining the air gap between the plurality of unit cells, the arm lengths of four L-shaped arcs the plurality of unit cell layers, and the outer square ring is placed at the edge of the four layered slot typed structures in the plurality of unit cells which increases a capacitance around the each of the four layered slot typed structures.

An incident wave illuminates the phase gradient metasurface lens to obtain a directive beam. The phase gradient metasurface and a transmitting antenna are connected, the transmitting antenna acts as a feeding source consisting of transmitting surface. The transmitting antenna is placed at a distance from phase gradient antenna, the spherical waves are illuminated on the phase gradient metasurface lens to obtain a directive beam by applying the phase compensation across the surface of the phase gradient metasurface lens. The effective phase compensation achieved by the phase gradient metasurface lens surface elements such as the modified alford-loop, air gap between the plurality of unit cell layers, the arm lengths of four L-shaped arcs, the plurality of unit cell layers, and outer square ring is placed at the edge of the plurality of unit cell layers.

The transmitting antenna is placed at a predetermined distance from center of the phase gradient metasurface lens, the predetermined distance is determined by simulating different distance between the transmitting antenna and the phase gradient metasurface lens. The position of the transmitting antenna is optimized to achieve 0-360° transmission phase variation. The predetermined distance determines a phase difference profile of the phase gradient metasurface lens, the phase difference is computed using equation 1. The phase difference is zero at the center of the phase gradient metasurface lens and it increases at edges of the phase gradient metasurface lens, and is represented as:

$$Δ θ ( m , n ) = \frac{2 π}{λ} ( \sqrt{{( m * p )}^{2} + {( n * p )}^{2} + {f}^{2}} - f ) \qquad ( 1 )$$

Here Δθ(m, n) is the phase difference at (m, n), m and n are the number of plurality of unit cells in x and y directions respectively, p is the periodicity, f is the distance, and λ is the wavelength of the incident wave.

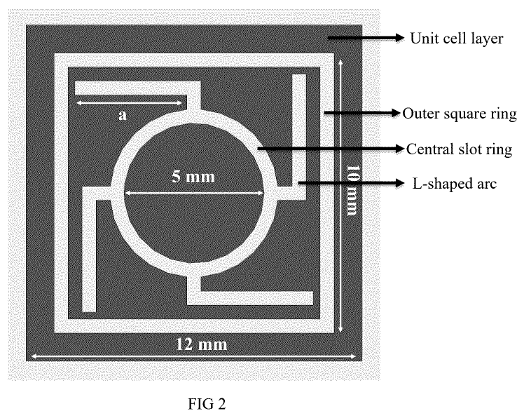

FIG. 2 illustrates a top view of a unit cell layer of a ring loaded alford-loop based phase gradient metasurface lens, in accordance with some embodiments of the present disclosure. FIG. 2 gives a schematic of the modified alford-loop structure which is enclosed by an outer square ring of a predefined length l. The modified alford-loop structure comprises of a central slot ring with a predefined inner radius r with four L-shaped arcs with a predefined arm length a and a predefined thickness t.

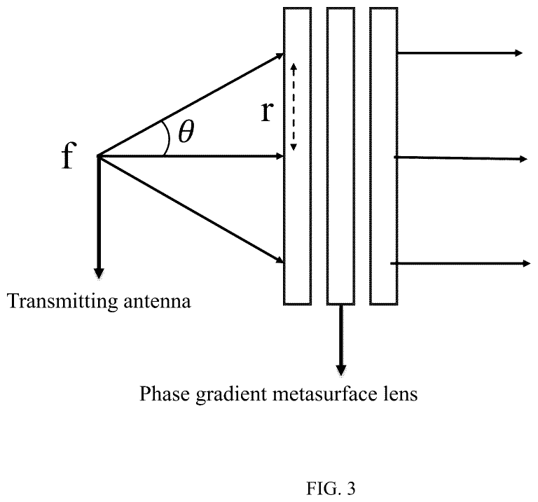

FIG. 3 illustrates an exemplary implementation of the ring loaded alford-loop based phase gradient metasurface lens of FIG. 1, according to some embodiments of the present disclosure. FIG. 3 gives a schematic representation of transmitting antenna placed at the predetermined distance from the center of the phase gradient metasurface lens. θ is angle of refraction of the incident wave, r is the from the center of the phase gradient metasurface lens. Transmitting antenna from the predetermined distance illuminates incident wave on the phase gradient metasurface lens to obtain the directive beams.

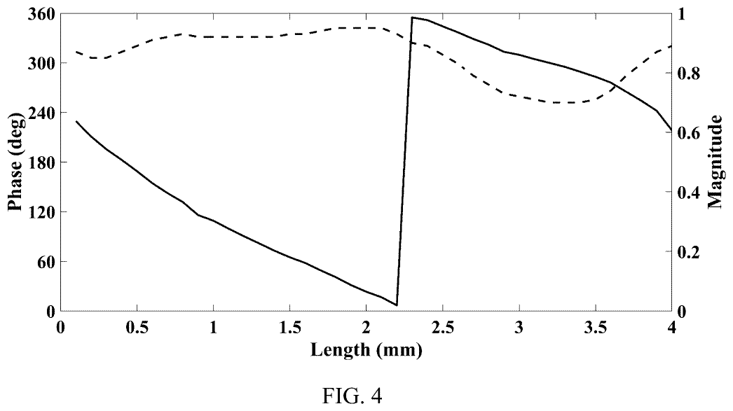

FIG. 4 illustrates the plot associated with the variation in transmission phase and magnitude with respect to the arm length of the multilayer unit cell of the ring loaded alford-loop based phase gradient metasurface lens according to some embodiments of the present disclosure. For example, varying the predefined arm length from 0.1 mm to 4 mm at a frequency of 11.05 GHZ, the transmission phase covers a complete 360° variation. The magnitude of transmission determines an overall realized gain of the phase gradient metsurface lens.

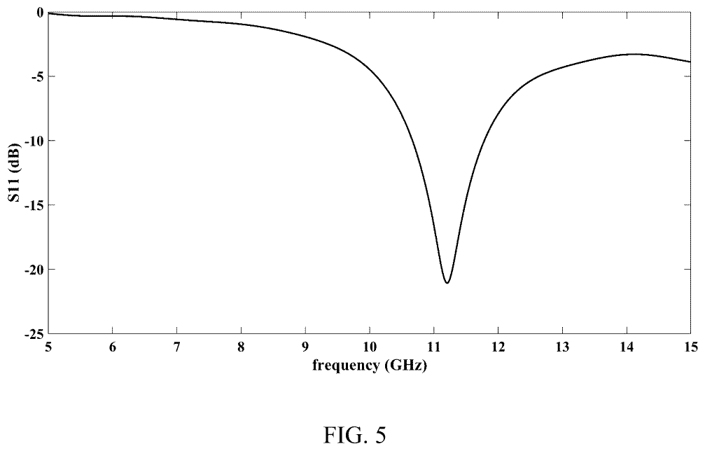

FIG. 5 illustrates the plot associated with response of a S11 bandwidth for a transmitting antenna according to some embodiments of the present disclosure. The S11 bandwidth represents the return loss of the transmitting antenna. FIG. 5 illustrates the S11 bandwidth is about 100 MHz for the transmitting antenna. The gain of the antenna was observed to be 7.6 dBi with a Half Power Beam Width (HPBW) of 76°.

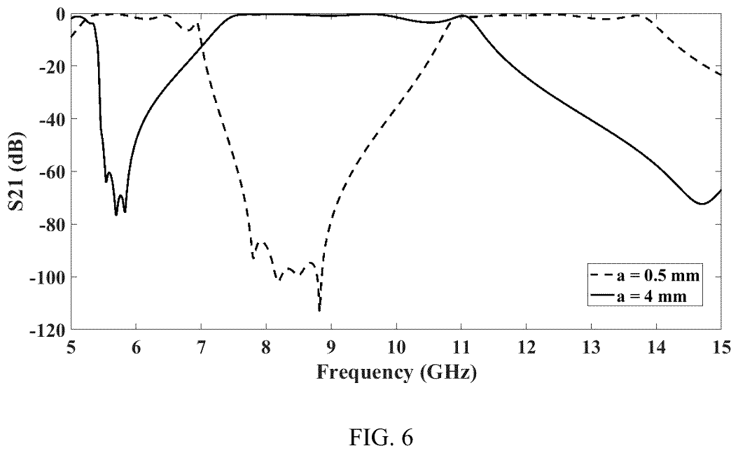

FIG. 6 illustrates the plot associated with the response of a S21 for the arm lengths of the multilayer unit cell of the ring loaded alford-loop based phase gradient metasurface lens according to some embodiments of the present disclosure. The S21 is a transmission coefficient indicates the gain of the phase gradient metasurface lens. For example, The S21 response for the arm lengths a=0.5 and 4 mm. As the length is increased, the magnitude response shifts to the lower frequency and the region of overlap depicts the bandwidth of the phase gradient metasurface lens, which is from 10.84 to 11.17 GHz.

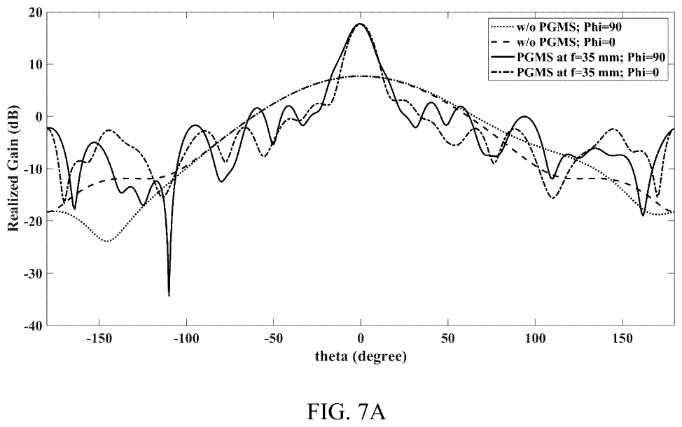

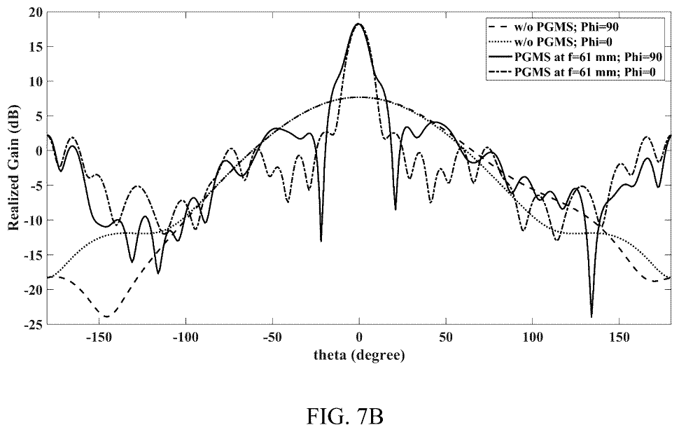

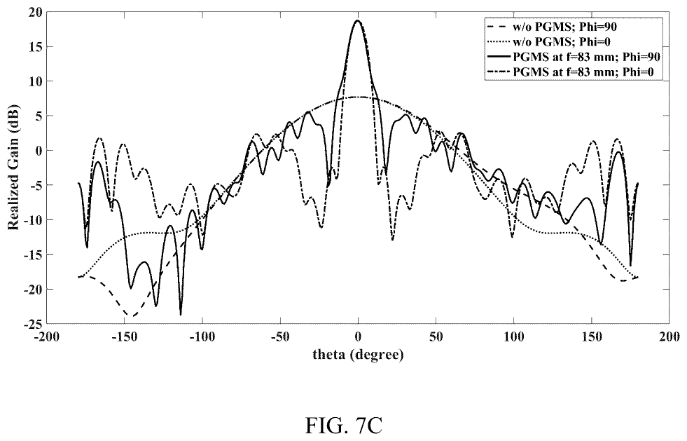

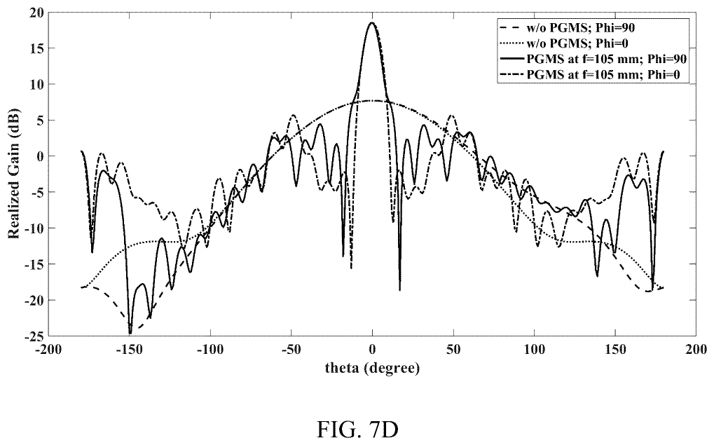

FIG. 7A through FIG. 7D illustrates plots associated with the gain of the ring loaded alford-loop based phase gradient metasurface lens and the transmitting antenna system, according to some embodiments of the present disclosure. FIG. 7A through FIG. 7D illustrates the results and compares the increase in the gain by the phase gradient metasurface (PGMS) lens-transmitting antenna system as the transmitting antenna is positioned further away from the phase gradient metasurface lens. FIG. 7A shows that at 35 mm, the gain of the phase gradient metasurface (PGMS) lens-transmitting antenna system is 17.7 dBi, which is a 10.1 dB enhancement, with approximately 63° reduction in half power beamwidth. The gain of the phase gradient metasurface (PGMS) lens-transmitting antenna system increases, as the transmitting antenna is placed further, as observed in FIG. 7B. FIG. 7C shows the gain of phase gradient metasurface (PGMS) lens-transmitting antenna system is maximum at the distance of 83 mm which corresponds to approximately 0.4 f/D with a realized gain of 18.7 dBi. The gain of the phase gradient metasurface (PGMS) lens-transmitting antenna system increases initially with distance but then saturates the distance increases further. The HPBW on the other hand reduces monotonically as distance increases.

TABLE 1

| | Realized | HPBW (degree) | | SLL (dB) | | F/B |
|---|---|---|---|---|---|---|
| Distance | Gain | E- | H- | E- | H- | ratio |
| (f/D) | (dBi) | Plane | plane | Plane | plane | (dB) |
| 0.18 | 17.7 | 13.4 | 13.2 | −15 | −14.5 | 20.1 |
| 0.3 | 18.2 | 11.3 | 11.4 | −14.1 | −15.5 | 16.2 |
| 0.4 | 18.7 | 10 | 10.6 | −13.2 | −15.9 | 23.77 |
| 0.5 | 18.5 | 9.2 | 10.1 | −14.1 | −12.8 | 18 |

Table 1 is a comparison of phase gradient metasurface (PGMS) lens-transmitting antenna system performance for positions at 11 GHz.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of ring loaded alford-loop based phase gradient metasurface lens for x-band applications. The present disclosure provides a phase gradient metasurface lens operating at 11.05 GHZ, consisting of plurality of unit cells arranged as M*N matrix along x-axis and y-axis of the phase gradient metasurface lens. The phase gradient metasurface lens comprises plurality of unit cells with the four layered slot typed structures. Each of the plurality of unit cell layers in four layered slot typed structures consisting of the modified alford-loop structure and is enclosed by an outer square ring, the modified alford-loop structure comprises the central slot ring with four L-shaped arcs and each of the plurality of unit cells are separated by predefined air gap. Each of the plurality of unit cell layers are identical to each other. The structure of phase gradient metasurface lens is studied by varying the number of layers of the plurality of unit cell, the air gap between the each of the plurality of unit cell layers in four layered slot typed structures, the arm length of the four L-shaped arcs and the distance between the transmitting antenna and the phase gradient metasurface lens. Based on the results, the ring loaded alford-loop based phase gradient metasurface lens designed to achieve transmission magnitude and 0-360° transmission phase variation for the incident wave.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A phase gradient metasurface lens, comprising:
a two dimensional periodic array of a plurality of unit cells arranged as a M*N matrix along x-axis and y-axis of the phase gradient metasurface lens,
wherein each of the plurality of unit cells is a four layered slot typed structures with a predefined periodicity,
wherein each of a plurality of unit cell layers in the four layered slot typed structure of each of the plurality of unit cells comprises a modified alford-loop structure and is enclosed by an outer square ring,
wherein the modified alford-loop structure comprises of a central slot ring with four L-shaped arcs,
wherein the four layered slot typed structures in the plurality of unit cells are separated by an air gap,
and wherein the four layered slot typed structures in each of the plurality of unit cells are identical.

2. The phase gradient metasurface lens of claim 1, wherein the outer square ring is placed at the edge of each of the four layered slot typed structures in the plurality of unit cells to achieve a wider transmission phase variation.

3. The phase gradient metasurface lens of claim 1, wherein the four L-shaped arc lengths are determined by varying an arm length of each L-shaped arc of modified alford-loop structure until a 0-360° transmission phase variation is achieved.

4. The phase gradient metasurface lens of claim 3, wherein a transmission magnitude and the 0-360° transmission phase variation are achieved by determining total number of the four layered slot typed structures in the plurality of unit cells and the air gap between the four layered slot typed structures.

5. The phase gradient metasurface lens of claim 4, wherein the outer square ring increases a capacitance around the each of the four layered slot typed structures, the modified alford-loop structure, the air gap between the four layered slot typed structures in the plurality of unit cells, the arm lengths of four L-shaped arcs, and the four layered slot typed structures in the plurality of unit cells together achieve the 360° transmission phase variation.

6. The phase gradient metasurface lens of claim 1, wherein the phase gradient metasurface lens is connected to a transmitting antenna acting as a feeding source, wherein the transmitting antenna illuminates the phase gradient metasurface lens by an incident wave, and wherein the incident wave is converted to a directive beam by the phase gradient metasurface lens.

7. The phase gradient metasurface lens of claim 6, wherein the transmitting antenna is placed at a distance from center of the phase gradient metasurface lens, wherein the position of the transmitting antenna from the phase gradient metasurface lens determines a phase difference profile of the phase gradient metasurface lens, and wherein the phase difference observed at the center of the phase gradient metasurface lens is zero and increases at edges of the phase gradient metasurface lens.
